(19) United States
(12) Patent Application Publication
(10) Pub. No.: US 2022/0321931 A1
(43) Pub. Date: Oct. 6, 2022

(54) ENHANCED TARGETED ADVERTISING FOR VIDEO STREAMING

(71) Applicant: ARRIS Enterprises LLC, Suwanee, GA (US)

(72) Inventors: Krishna Prasad PANJE, Bengaluru (IN); Lakshmi ARUNKUMAR, Bengaluru (IN)

(73) Assignee: ARRIS Enterprises LLC, Suwanee, GA (US)

(21) Appl. No.: 17/709,114

(22) Filed: Mar. 30, 2022

Related U.S. Application Data
(60) Provisional application No. 63/168,509, filed on Mar. 31, 2021.

(51) Int. Cl. H04N 21/234; H04N 21/84; G06Q 30/02

(52) U.S. Cl. CPC H04N 21/23424; H04N 21/84; G06Q 30/0277

(57) ABSTRACT

A system for enhanced trickplay for video streaming.

### CROSS REFERENCE TO RELATED APPLICATIONS

This application claims the benefit of U.S. Provisional Patent Application Ser. No. 63/168,509 filed Mar. 31, 2021.

### BACKGROUND

The subject matter of this application relates to enhanced targeted advertising for video streaming.

Cable system operators and other network operators provide streaming media to a gateway device for distribution in a consumer's home. The gateway device offers a singular point to access different types of content, such as live content, on-demand content, online content, over-the-top content, and content stored on a local or a network based digital video recorder. The gateway enables a connection to home network devices. The connection may include, for example, connection to a WiFi router or a Multimedia over Coax Alliance (MoCA) connection that provide IP over in-home coaxial cabling.

Consumers prefer to use devices that are compliant with standard protocols to access streaming video from the gateway device, so that all the devices within the home are capable of receiving streaming video content provided from the same gateway device. HTTP Live Streaming (HLS) is an adaptive streaming communications protocol created by Apple to communicate with iOS, Apple TV devices, and Macs running OSX Snow Leopard or later. HLS is capable of distributing both live and on-demand files, and is the sole technology available for adaptively streaming to Apple devices.

### BRIEF DESCRIPTION OF THE DRAWINGS

For a better understanding of the invention, and to show how the same may be carried into effect, reference will now be made, by way of example, to the accompanying drawings, in which:

FIG. 1 illustrates an overview of a cable system.

FIG. 2 illustrates HLS streaming video content.

FIG. 3 illustrates a HLS mater playlist.

FIG. 4 illustrates a HLS VOD playlist.

FIG. 5 illustrates an event playlist.

FIG. 6 illustrates an updated event playlist.

FIG. 7 illustrates a sliding window playlist.

FIG. 8 illustrates an updated sliding window playlist.

FIG. 9 illustrates a further updated sliding window playlist.

FIG. 10 illustrates a content server and a player for video content.

FIG. 11 illustrates a content creator and a content server identifying content.

FIG. 12 illustrates a player that identifies content for impactful rendering.

FIG. 13 illustrates a content server and a player with a modified video content.

### DETAILED DESCRIPTION

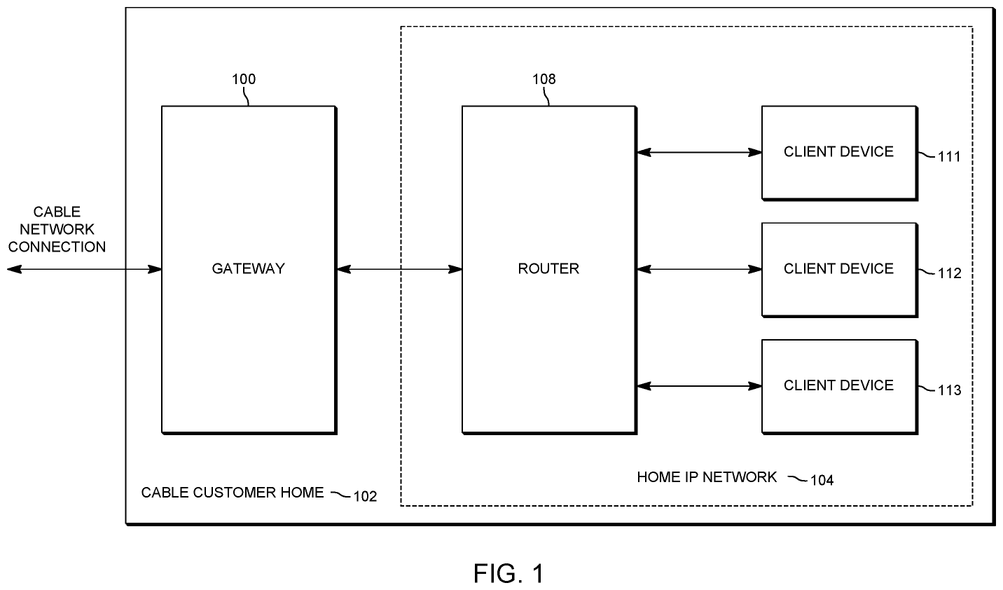

Referring to FIG. 1, a cable system overview is illustrated with a cable network connection provided to a gateway 100 of a cable customer's home 102. The cable network connection provided to the gateway 100 may be from a cable system operator or other streaming content provider, such as a satellite system. The gateway 100 provides content to devices in a home network 104 in the consumer's home 102. The home network 104 may include a router 106 that receives IP content from the gateway 100 and distributes the content over a WiFi or a cable connection to client devices 111, 112, 113. The router 106 may be included as part of the gateway 100. In general, the cable network connection, or other types of Internet or network connection, provides streaming media content to client devices in any suitable manner. The streaming media content may be in the form of HTTP Live Streaming (HLS), Dynamic Adaptive Streaming over HTTP (DASH), or otherwise.

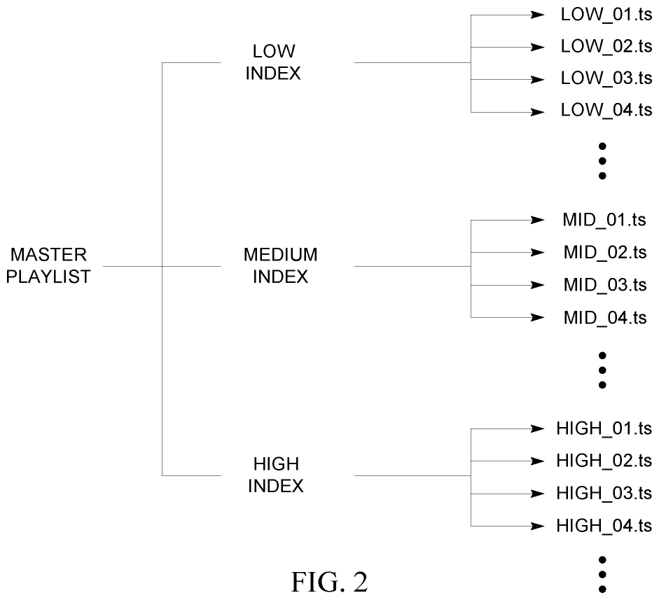

Referring to FIG. 2, at a high level HLS enables adaptive streaming of video content, by creating multiple files for distribution to a media player, which adaptively changes media streams being obtained to optimize the playback experience. HLS is a HTTP-based technology so that no streaming server is required, so all the switching logic resides on the player. To distribute content to HLS players, the video content is encoded into multiple files at different data rates and divided into short chucks, each of which is typically between 5-10 seconds long. The chunks are loaded onto a HTTP server along with a text based manifest file with a .M3U8 extension that directs the player to additional manifest files for each of the encoded media streams. The short video content media files are generally referred to as “chunked” files.

The player monitors changing bandwidth conditions over time to the player. If the change in bandwidth conditions indicates that the stream should be changed to a different bit rate, the player checks the master manifest file for the location of additional streams having different bit rates. Using a stream specific manifest file for a selected different stream, the URL of the next chuck of video data is requested. In general, the switching between video streams by the player is seamless to the viewer.

A master playlist (e.g., manifest file) describes all of the available variants for the content. Each variant is a version of the stream at a particular bit rate and is contained in a separate variant playlist (e.g., manifest file). The client switches to the most appropriate variant based on the measured network bit rate to the player. The master playlist isn't typically re-read. Once the player has read the master playlist, it assumes the set of variants isn't changing. The stream ends as soon as the client sees the EXT-X-ENDLIST tag on one of the individual variant playlists.

For example, the master playlist may include a set of three variant playlists. A low index playlist, having a relatively low bit rate, may reference a set of respective chunk files. A medium index playlist, having a medium bit rate, may reference a set of respective chunk files. A high index playlist, having a relatively high bit rate, may reference a set of respective chunk files.

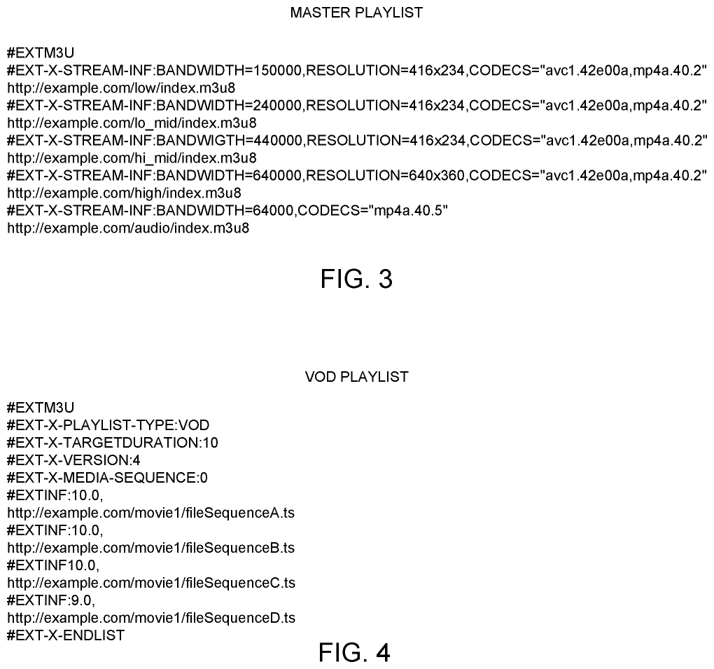

Referring to FIG. 3, an exemplary master playlist that defines five different variants is illustrated. Exemplary tags used in the master playlist may include one or more of the following.

EXTM3U: Indicates that the playlist is an extended M3U file. This type of file is distinguished from a basic M3U file by changing the tag on the first line to EXTM3U. All HLS playlists start with this tag.

EXT-X-STREAM-INF: Indicates that the next URL in the playlist file identifies another playlist file. The EXT-X-STREAM-INF tag has the following parameters.

AVERAGE-BANDWIDTH: An integer that represents the average bit rate for the variant stream.

BANDWIDTH: An integer that is the upper bound of the overall bitrate for each media file, in bits per second. The upper bound value is calculated to include any container overhead that appears or will appear in the playlist.

FRAME-RATE: A floating-point value that describes the maximum frame rate in a variant stream.

HDCP-LEVEL: Indicates the type of encryption used. Valid values are TYPE-0 and NONE. Use TYPE-0 if the stream may not play unless the output is protected by HDCP.

RESOLUTION: The optional display size, in pixels, at which to display all of the video in the playlist. This parameter should be included for any stream that includes video.

VIDEO-RANGE: A string with valid values of SDR or PQ. If transfer characteristic codes 1, 16, or 18 aren't specified, then this parameter must be omitted.

CODECS: (Optional, but recommended) A quoted string containing a comma-separated list of formats, where each format specifies a media sample type that's present in a media segment in the playlist file. Valid format identifiers are those in the ISO file format name space defined by RFC 6381 [RFC6381].

Referring to FIG. 4, one of the types of video playlists include a video on demand (VOD) playlist. For VOD sessions, media files are available representing the entire duration of the presentation. The index file is static and contains a complete list of URLs to all media files created since the beginning of the presentation. This kind of session allows the client full access to the entire program.

Exemplary tags used in the VOD playlist may include one or more of the following.

EXTM3U: Indicates that the playlist is an extended M3U file. This type of file is distinguished from a basic M3U file by changing the tag on the first line to EXTM3U. All HLS playlists start with this tag.

EXT-X-PLAYLIST-TYPE: Provides mutability information that applies to the entire playlist file. This tag may contain a value of either EVENT or VOD. If the tag is present and has a value of EVENT, the server must not change or delete any part of the playlist file (although it may append lines to it). If the tag is present and has a value of VOD, the playlist file must not change.

EXT-X-TARGETDURATION: Specifies the maximum media-file duration.

EXT-X-VERSION: Indicates the compatibility version of the playlist file. The playlist media and its server must comply with all provisions of the most recent version of the IETF Internet-Draft of the HTTP Live Streaming specification that defines that protocol version.

EXT-X-MEDIA-SEQUENCE: Indicates the sequence number of the first URL that appears in a playlist file. Each media file URL in a playlist has a unique integer sequence number. The sequence number of a URL is higher by 1 than the sequence number of the URL that preceded it. The media sequence numbers have no relation to the names of the files.

EXTINF: A record marker that describes the media file identified by the URL that follows it. Each media file URL must be preceded by an EXTINF tag. This tag contains a duration attribute that's an integer or floating-point number in decimal positional notation that specifies the duration of the media segment in seconds. This value must be less than or equal to the target duration.

EXT-X-ENDLIST: Indicates that no more media files will be added to the playlist file.

The VOD playlist example in FIG. 4 uses full pathnames for the media file playlist entries. While this is allowed, using relative pathnames is preferable. Relative pathnames are more portable than absolute pathnames and are relative to the URL of the playlist file. Using full pathnames for the individual playlist entries often results in more text than using relative pathnames.

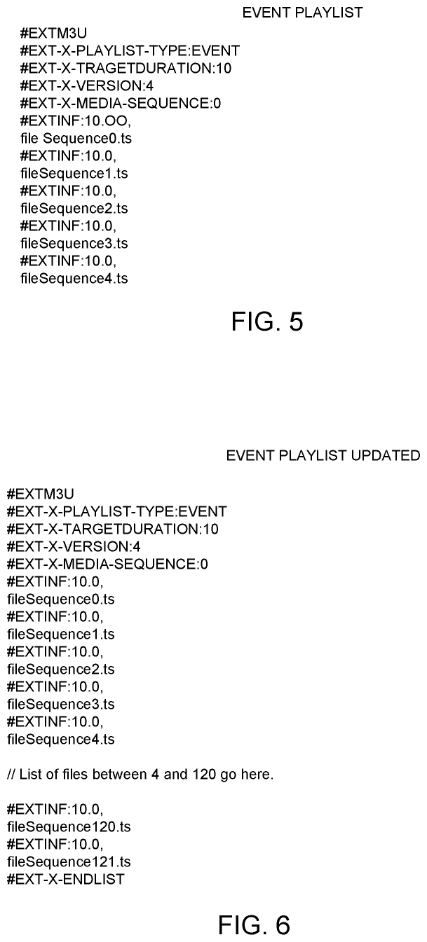

Referring to FIG. 5, an event playlist is specified by the EXT-X-PLAYLIST-TYPE tag with a value of EVENT. It doesn't initially have an EXT-X-ENDLIST tag, indicating that new media files will be added to the playlist as they become available.

Exemplary tags used in the EVENT playlist may include one or more of the following.

EXTM3U: Indicates that the playlist is an extended M3U file. This type of file is distinguished from a basic M3U file by changing the tag on the first line to EXTM3U. All HLS playlists start with this tag.

EXT-X-PLAYLIST-TYPE: Provides mutability information that applies to the entire playlist file. This tag may contain a value of either EVENT or VOD. If the tag is present and has a value of EVENT, the server must not change or delete any part of the playlist file (although it may append lines to it). If the tag is present and has a value of VOD, the playlist file must not change.

EXT-X-TARGETDURATION: Specifies the maximum media-file duration.

EXT-X-VERSION: Indicates the compatibility version of the playlist file. The playlist media and its server must comply with all provisions of the most recent version of the IETF Internet-Draft of the HTTP Live Streaming specification that defines that protocol version.

EXT-X-MEDIA-SEQUENCE: Indicates the sequence number of the first URL that appears in a playlist file. Each media file URL in a playlist has a unique integer sequence number. The sequence number of a URL is higher by 1 than the sequence number of the URL that preceded it. The media sequence numbers have no relation to the names of the files.

EXTINF: A record marker that describes the media file identified by the URL that follows it. Each media file URL must be preceded by an EXTINF tag. This tag contains a duration attribute that's an integer or floating-point number in decimal positional notation that specifies the duration of the media segment in seconds. This value must be less than or equal to the target duration.

Items are not removed from the playlist when using the EVENT tag; rather new segments are appended to the end of the file. New segments are added to the end of the file until the event has concluded, at which time the EXT-X-ENDLIST tag may be appended. Referring to FIG. 6, the same playlist is shown after it's been updated with new media URIs and the event has ended. Event playlists are typically used when you want to allow the user to seek to any point in the event, such as for a concert or sports event.

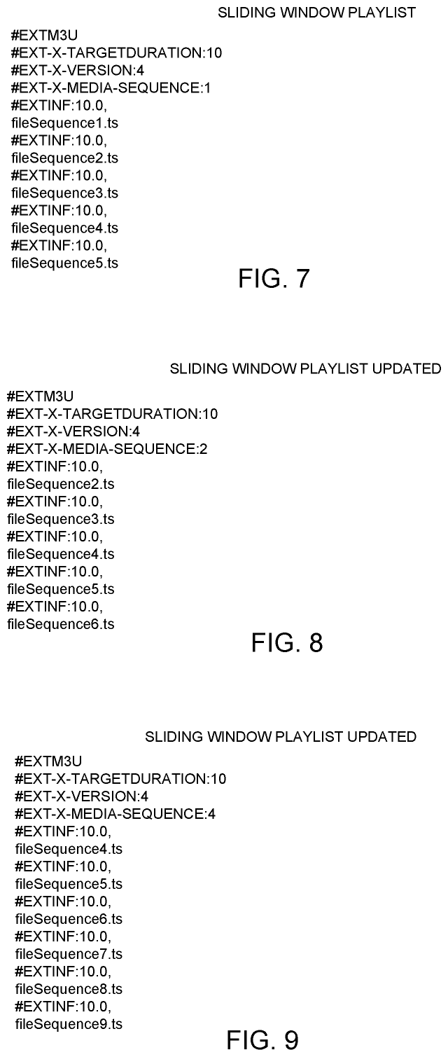

Referring to FIG. 7, a live playlist (sliding window) is an index file that is updated by removing media URIs from the file as new media files are created and made available. The EXT-X-ENDLIST tag isn't present in the live playlist, indicating that new media files will be added to the index file as they become available.

Exemplary tags used in the live playlist may include one or more of the following.

EXTM3U: Indicates that the playlist is an extended M3U file. This type of file is distinguished from a basic M3U file by changing the tag on the first line to EXTM3U. All HLS playlists must start with this tag.

EXT-X-TARGETDURATION: Specifies the maximum media-file duration.

EXT-X-VERSION: Indicates the compatibility version of the playlist file. The playlist media and its server must comply with all provisions of the most recent version of the IETF Internet-Draft of the HTTP Live Streaming specification that defines that protocol version.

EXT-X-MEDIA-SEQUENCE: Indicates the sequence number of the first URL that appears in a playlist file. Each media file URL in a playlist has a unique integer sequence number. The sequence number of a URL is higher by 1 than the sequence number of the URL that preceded it. The media sequence numbers have no relation to the names of the files.

EXTINF: A record marker that describes the media file identified by the URL that follows it. Each media file URL must be preceded by an EXTINF tag. This tag contains a duration attribute that's an integer or floating-point number in decimal positional notation that specifies the duration of the media segment in seconds. This value must be less than or equal to the target duration. In addition, the live playlist can use an EXT-X-ENDLIST tag to signal the end of the content. Also, the live playlist preferably does not include the EXT-X-PLAYLIST-TYPE type.

Referring to FIG. 8, the same playlist of FIG. 7 is shown after it has been updated with new media URIs.

Referring to FIG. 9, the playlist FIG. 8 continues to be updated as new media URIs are added.

Another adaptive streaming technology is referred to as Dynamic Adaptive Streaming over HTTP (DASH), also generally referred to as MEGP-DASH, that enables streaming of media content over the Internet delivered from conventional HTTP web servers. MPEG-DASH employs content broken into a sequence of small HTTP-based file segments, where each segment contains a short interval of playback time of content. The content is made available at a variety of different bit rates. While the content is being played back at an MPEG-DASH enabled player, the player uses a bit rate adaptation technique to automatically select the segment with the highest bit rate that can be downloaded in time for playback without causing stalls or re-buffering events in the playback. In this manner, a MPEG-DASH enabled video player can adapt to changing network conditions and provide high quality playback with fewer stalls or re-buffering events. DASH is described in ISO/IEC 23009-1:2014 “Information technology Dynamic adaptive streaming over HTTP (DASH)— Part 1: Media presentation description and segment formats”, incorporated by reference herein in its entirety.

In many video streaming technologies, including MPEG-2, the video frames are encoded as a series of frames to achieve data compression and typically provided using a transport stream. Each of the frames of the video are typically compressed using either a prediction based technique and a non-prediction based technique. An I frame is a frame that has been compressed in a manner that does not require other video frames to decode it. A P frame is a frame that has been compressed in a manner that uses data from a previous frame(s) to decode it. In general, a P frame is more highly compressed than an I frame. A B frame is a frame that has been compressed in a manner that uses data from both previous and forward frames to decode it. In general, a B frame is more highly compressed than a P frame. The video stream is therefore composed of a series of I, P, and B frames. MPEG-2 is described in ISO/IEC 13818-2:2013 “Information technology—Generic coding of moving pictures and associated audio information—Part 2: Video” incorporated by reference herein in its entirety. In some encoding technologies, including H.264, an IDR (instantaneous decoder refresh) frame is made up an intra code picture that also clears the reference picture buffer. However, for purposes of discussion the I frame and the IDR frame will be referred to interchangeably. In some encoding technologies, the granularity of the prediction types may be brought down to a slice level, which is a spatially distinct region of a frame that is encoded separately from any other regions in the same frame. The slices may be encoded as I-slices, P-slices, and B-slices in a manner akin to I frames, P-frames, and B-frames. However, for purposes of discussion I frame, P frame, and B frame are also intended to include I-slice, P-slice, and B-slice, respectively. In addition, the video may be encoded as a frame or a field, where the frame is a complete image and a field is a set of odd numbered or even numbered scan lines composing a partial image. However, for purposes of discussion both “frames” and “pictures” and “fields” are referred to herein as “frames”. H.264 is described in ITU-T (2019) “SERIES H: AUDIOVISUAL AND MULTIMEDIA SYSTEMS Infrastructure of audiovisual services—Coding of moving video”, incorporated by reference herein in its entirety.

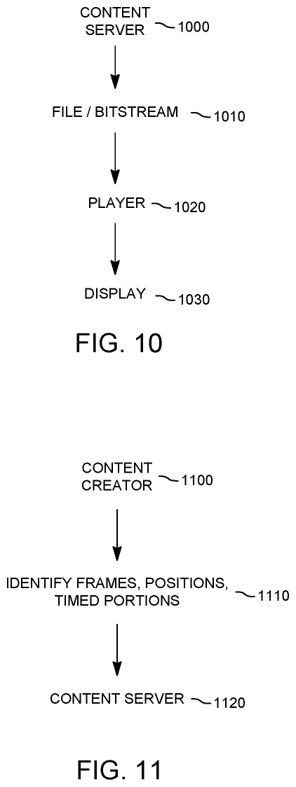

Referring to FIG. 10, typically a content server 1000 creates files 1010 that are made available, or otherwise provides a bitstream, of video content to the player 1020 that renders the video content at a normal frame rate for a display 1030. Often the bandwidth required for the video content is dependent on the selected resolution of the video, each of which typically requires a different amount of bandwidth to be effectively received by the player for rendering in real-time. In many cases, the user desires to fast forward and/or fast rewind the video content to skip over portions that are of less interest. For example, the fast forward and/or fast reverse may be at 2× the normal play rate, at 4× the normal play rate, at 8× the normal play rate, and/or at 16× the normal play rate. For example, the user may fast forward over portions that they have already seen, fast rewind to reset the play location so they can review a portion again at normal play rate, or otherwise fast forward to view a particular portion of interest that occurs later in the video. In the case of chunk files, the server 1000 may create one or more fast forward playlists and associated fast forward chuck files, at different resolution if desired, that the player 1020 renders. Typically, the fast forward chunk files include a series of I frames, or otherwise fewer frames, than the corresponding frames in the live streaming audio video content for a temporal time period. In other cases, the player may receive typical chunk files and process them in a manner to provide a fast forward and/or fast rewind series of frames that are rendered.

While such fast forwarding and fast rewinding is convenient for the user, the server often inserts advertisements into the video stream in a suitable manner. For example, the advertisements may be included as part of the chunk files, additional chunk files may be included that provide the advertisements, advertisements may be selected and/or obtained locally by the player, or otherwise the advertisements are inserted into the bitstream in some manner. With the advertisements included as part of the bitstream/files they are likewise subject to fast forward and/or fast rewind, in the same manner as the remainder of the video content, which tends to obscure the nature of the advertisement. In addition, the video content may be stored locally with the player, such as within the player or a storage device connected to the player, and likewise being subject to fast forward and/or fast rewind. With the nature of the advertisement obscured, the impact of the advertisement is reduced and thus the value of the advertisement to the advertiser. Often the advertisements are targeted to the particular user based upon their profile or demography.

It was determined that particular frames of an advertisement tend to have a greater impact on the user than other frames of the advertisement. The impact of particular frames of the video content more succinctly convey the core message of the advertisement and thus have a greater impact on the user. To provide a more impactful presentation of the advertisement, during the fast forward of the advertisement and/or the fast rewind of the advertisement it is desirable to identify such frames of the advertisement so that they may be selected from among the other frames of the advertisement for rendering during the fast rewind and/or fast forward of the advertisement in a more impactful manner. By way of example, such frames may include the advertiser's name, advertiser's product, advertiser's make of product, advertiser's model of product, and/or the advertiser's offer.

Referring to FIG. 11, the content creator 1100 (or otherwise content producer) identifies the frames and/or positions and/or timed portions 1110 of the advertisement. The content creator 1100 then provides the advertisements to the content server 1020 together with metadata identifying the frames and/or positions and/or timed portions of the advertisement that are more impactful than other portions. The content server 1020 may mark such frames and/or positions and/or timed portions of the advertisement in some manner such as using metadata identifying the position of such frames and/or positions and/or timed portions within the advertisement. By way of example, this information may be included in the playlist for HLS, may be included in a private packet identifier of a transport stream identifying the corresponding presentation time stamps for the video frame(s), or otherwise.

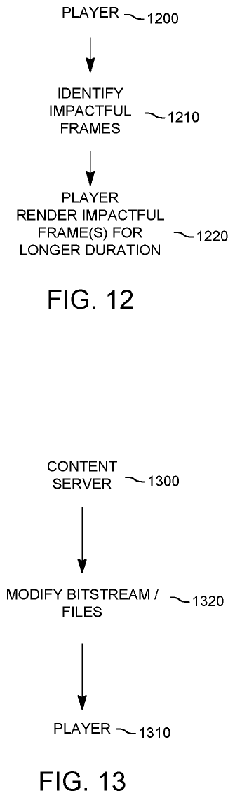

Referring to FIG. 12, in the case that the video content is stored locally or otherwise provided by the content server, that includes advertisements of video content included therein, the player 1200 receives the video content. In the case of a fast forward and/or fast rewind by the player 1200 of the video content, the player 1200 processes the associated metadata, the private packet identifier, or otherwise, to identify impactful frames of any advertisements that are subject to a fast forward and/or fast rewind 1210. All or a selected subset of the impact frame(s) 1210 are rendered by the player 1200 for a longer duration than they would otherwise be rendered if the advertisement were rendered with a standard fast forward and/or fast rewind rate 1220. By way of example, for a 30 second advertisement, that is fast forwarded at a 2× rate, would result in a 15 second advertisement. If in this example, there are 3 frames identified as impactful, then each of those 3 frames may be rendered for 5 seconds each during the fast forward of the advertisement. In this manner, the frames provide an impactful experience to the user.

Referring to FIG. 13, in the case that the video content is provided in real-time to the player in a manner in accordance with the fast forward and/or fast rewind the content server 1300 may modify the files and/or bitstream. When a player 1310 requests fast forward and/or fast rewind from the content server 1300 or is otherwise playing video content using fast forward and/or fast rewind with content being provided from the content server 1300, during a time that an advertisement is being rendered or to be rendered by the player 1310, the content server 1300 may modify the bitstream and/or files 1320 accordingly. The files and/or bitstream are modified 1320 in a manner such that they are rendered in a manner that impactful frame(s) of the advertisement are provided to the player 1310 for being rendered. All or a selected subset of the impact frame(s) are rendered by the player 1310 for a longer duration than they would otherwise be rendered if the advertisement were rendered with a standard fast forward and/or fast rewind rate. By way of example, for a 30 second advertisement, that is fast forwarded at a 2× rate, would result in a 15 second advertisement. If in this example, there are 3 frames identified as impactful, then each of those 3 frames may be rendered for 5 seconds each during the fast forward of the advertisement by providing a 15 second bitstream and/or file(s) containing the 3 frames to be rendered for an extended duration. In this manner, the frames provide an impactful experience to the user.

Moreover, each functional block or various features in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

We claim:

1. A method of rendering video content comprising:
(a) receiving a first portion of said video content by a player that provides said video content in a manner suitable to be rendered at a normal frame rate;
(b) receiving a second portion of said video content, a first part of which includes non-advertisement video content and a second part of which includes an advertisement, by said player that provides said video content in a manner suitable to be rendered at a fast forward rate or a fast rewind rate compared to said normal frame rate;
(c) wherein first part of which that includes said non-advertisement video content is modified in a first manner for said fast forward rate or said fast rewind rate, and said second part of which that includes said advertisement video content is modified in a second manner for said fast forward rate or said fast rewind rate, where said first manner is different than said second manner.

2. The method of claim 1 further comprising said player receiving said video content over a cable network.

3. The method of claim 1 wherein said video content is provided as a HTTP live streaming video stream.

4. The method of claim 1 wherein said audio video content is provided as a dynamic adaptive streaming over HTTP video stream.

5. The method of claim 1 wherein said player receives said first portion of said video content and said second portion of said video content from a content server through a network.

6. The method of claim 1 wherein selected frames of said second part that includes said advertisement video content are identified for being modified in said second manner.

7. The method of claim 6 wherein said identified includes said advertisement video content that shows at least one of an advertise's name, an advertiser's product, an advertiser's make of product, an advertiser's model of produce, and an advertiser's offer.

8. The method of claim 6 wherein said identified is provided together with said advertisement video content by a content creator.

9. The method of claim 1 wherein selected positions of said second part that includes said advertisement video content are identified for being modified in said second manner.

10. The method of claim 1 wherein selected timed portions of said second part that includes said advertisement video content are identified for being modified in said second manner.

11. The method of claim 1 wherein selected at least one of frames, positions, and timed portions of said second part that includes said advertisement video content are identified for being modified in said second manner in metadata.

12. The method of claim 11 wherein said metadata is included in a playlist.

13. The method of claim 11 wherein said metadata is included in a private packet identifier of a transport stream.

14. The method of claim 1 wherein selected frames of said second part that includes said advertisement video content are rendered for a longer duration than a frame of said first part that does not include said advertisement video content.

15. A method of rendering video content comprising:
(a) receiving a first portion of said video content by a player that provides said video content in a manner suitable to be rendered at a first frame rate;
(b) receiving a second portion of said video content, a first part of which includes non-advertisement video content and a second part of which includes an advertisement, by said player that provides said video content in a manner suitable to be rendered at a second rate greater than said first frame rate or a third rate lesser than said first frame rate;
(c) wherein first part of which that includes said non-advertisement video content is modified in a first manner for said second rate or said third rate, and said second part of which that includes said advertisement video content is modified in a second manner for said second rate or said third rate, where said first manner is different than said second manner.
